(19) United States
(12) Patent Application Publication
(10) Pub. No.: US 2026/0253564 A1
(43) Pub. Date: Aug. 27, 2026

(54) POWER SUPPLY DEVICE AND DISPLAY POWER SUPPLY DEVICE

(71) Applicant: LX SEMICON CO., LTD., Daejeon (KR)

(72) Inventors: Won Suk JANG, Daejeon (KR); Young Kook AHN, Daejeon (KR); Jong Hyun YOON, Daejeon (KR); Woo Seok CHOI, Daejeon (KR)

(73) Assignee: LX SEMICON CO., LTD., Daejeon (KR)

(21) Appl. No.: 19/161,921

(22) PCT Filed: Mar. 5, 2024
(86) PCT No.: PCT/KR2024/002770

§ 371 Date: Sep. 3, 2025

(30) Foreign Application Priority Data
Mar. 7, 2023 (KR) 10-2023-0029777

(51) Int. Cl. G09G 3/36; H02M 1/088; H02M 3/158

(52) U.S. Cl. CPC G09G 3/3696; H02M 1/088; H02M 3/1582; G09G 3/3688; G09G 2330/021

(57) ABSTRACT

The embodiment may relate to a power supply device that supplies a plurality of voltages. The embodiment may provide a technology for supplying a negative voltage generated in one power conversion circuit to an inductor of another power conversion circuit to improve the duty of another power conversion circuit and increase the power conversion efficiency of the power supply device as a whole.

### TECHNICAL FIELD

The present invention relates to a power supply device and a device for supplying power to a display device.

### BACKGROUND ART

A display device includes a device that supplies power to each component, i.e., a power supply device. The power supply device includes a power management integrated circuit (PMIC).

The power supply device mainly converts system power supplied from a commercial power source, battery, etc. to be suitable for the characteristics of each component included in the display device. For example, when a voltage of the system power and operating voltages of component are different, the power supply device converts the voltage of the system power to the operating voltages of the component and then supplies the converted operating voltages to the components.

The power supply device may include various types of power conversion circuits to generate voltages suited to the characteristics of the components. For example, the power supply device may include a buck-type power conversion circuit, a boost-type power conversion circuit, or a buck-boost-type power conversion circuit.

The types of power conversion circuit has different power conversion efficiency characteristics, but it is unlikely that a designer will be able to determine the type of power conversion circuit based solely on the power conversion efficiency of each type. For example, when the voltage of the system power has a positive polarity and a driving voltage of the first component is provided with a negative polarity, the designer may be forced to use a buck-boost type. As another example, when a driving voltage of the second component is higher than the voltage of the system power, the designer may be forced to use a boost type.

In this way, when designing a power supply device, there are cases where a specific type of power conversion circuit must be used. Even in these cases, the development of technology that can increase the efficiency of the power conversion circuit is required.

### DISCLOSURE

### Technical Problem

The embodiment aims to solve the above-mentioned problems and other problems.

Another object of the embodiment is to provide a power supply device and a display power supply device capable of increasing an efficiency of the power supply device.

Another object of the embodiment is to provide a power supply device and a display power supply device capable of improving an efficiency of a power supply device that supplies a voltage with a negative polarity by utilizing the voltage with a negative polarity.

Another object of the embodiment is to provide a power supply device and a display power supply device capable of improving the duty cycle of a power conversion circuit used in the power supply device, thereby increasing overall efficiency.

Another object of the embodiment is to provide a power supply device and a display power supply device capable of improving an efficiency of a buck-boost-type power conversion circuit and a boost-type power conversion circuit.

The technical problems of the embodiment are not limited to those described in this section, but comprise those that may be understood through the description of the invention.

### Technical Solution

In order to achieve the above or other objects, according to an aspect of the present invention, a display power supply device, comprising: a first power conversion circuit configured to generate a first display driving voltage having a negative polarity; a second power conversion circuit comprising: a first power switch configured to transmit an input voltage to a first node, an inductor having one end electrically connected to the first node and the other end to which the first display driving voltage is supplied, and a second power switch configured to control an electrical connection between the first node and a first load, wherein the second power conversion circuit is configured to generate a second display driving voltage having a negative polarity by controlling the first and second power switches in a buck-boost mode.

An absolute value of a voltage level of the first display driving voltage may be lower than an absolute value of a voltage level of the second display driving voltage.

The first power conversion circuit may supply the first display driving voltage to an N-DAC of a device that alternately supplies positive and negative voltages to a pixel disposed on a display panel using a P-DAC and the N-DAC.

The second power conversion circuit may be a device that drives a gate terminal of a driving transistor disposed in the pixel, and may supply the second display driving voltage The second display driving voltage may be generated before the first display driving voltage.

The first power conversion circuit may convert the input voltage to generate the first display driving voltage.

The first power conversion circuit comprises a buck-boost type power stage in which the input voltage is transferred to one side of the inductor and a ground voltage is supplied to the other side thereof.

The first display driving voltage may have a voltage level lower than ground voltages of the first load and a second load.

A duty of the second power switch may be determined by dividing a value obtained by subtracting the first display driving voltage from the second display driving voltage by a value obtained by subtracting the input voltage from the second display driving voltage.

The second power conversion circuit may further comprise a third power switch configured to control an electrical connection between the first node and a second load, and may control the first and third power switches to further generate a third display driving voltage having a negative polarity.

According to another aspect of the embodiment to achieve the above or other objects, a display power supply device, comprising: a first power conversion circuit configured to generate a first display driving voltage having a negative polarity; and a second power conversion circuit comprising: an inductor having one end electrically connected to a first node and the other end to which an input voltage is supplied, a first power switch configured to transmit a first display driving voltage to the first node, and a second power switch configured to control an electrical connection between the first node and a first load, wherein the second power conversion circuit may generate a second display driving voltage by controlling the first and second power switches in a boost mode.

The input voltage and the second display driving voltage may have positive polarities, and a voltage level of the input voltage may be lower than a voltage level of the second display driving voltage.

The first power conversion circuit may supply the first display driving voltage to an N-DAC of a device that alternately supplies positive and negative voltages to a pixel disposed on a display panel using a P-DAC and the N-DAC.

A driving transistor disposed in the pixel may be turned on by the second display driving voltage.

The first display driving voltage may have a voltage level lower than a ground voltage of the first load.

A duty of the second power switch may be determined by dividing a value obtained by subtracting the first display driving voltage from the input voltage by a value obtained by subtracting the first display driving voltage from the second display driving voltage.

The second power conversion circuit may further comprise a third power switch configured to control an electrical connection between the first node and a second load, and may control the first and third power switches to further generate a third display driving voltage.

According to another aspect of the embodiment to achieve the above or other objects, a power supply device, comprising: a first power conversion circuit configured to generate a first voltage having a negative polarity; and a second power conversion circuit configured to supply an input voltage and the first voltage to one end and the other end of an inductor, respectively, by controlling a first power switch, and to output electric energy generated in the inductor as a second voltage by controlling a second power switch.

The first voltage may have a voltage level lower than a ground voltage of a load to which the second voltage is supplied.

The first power conversion circuit may operate in a buck-boost mode, and the second power conversion circuit may operate in a buck-boost mode or a boost mode.

### Advantageous Effects

The effects of the power supply device and the display power supply device according to the embodiments are described as follows.

According to at least one of the embodiments, the efficiency of the power supply device can be increased.

According to at least one of the embodiments, in a power supply device that supplies a voltage having a negative polarity, the efficiency of the power supply device can be further increased by utilizing the voltage having a negative polarity.

According to at least one of the embodiments, the duty cycle of the power conversion circuit used in the power supply device can be improved, thereby increasing the overall efficiency.

According to at least one of the embodiments, the efficiency of the buck-boost-type power conversion circuit and the boost-type power conversion circuit can be increased.

Further scope of applicability of the embodiments will become apparent from the detailed description below. However, since various changes and modifications within the spirit and scope of the embodiments will be apparent to those skilled in the art, it should be understood that the detailed description and specific embodiments, such as preferred embodiments, are given by way of example only.

### DESCRIPTION OF DRAWINGS

FIG. 1 is a block diagram of a display device according to an embodiment.

FIG. 2 illustrates pixels of a display panel according to an embodiment.

FIG. 3 is a block diagram of a data driving device according to an embodiment.

FIG. 4 is a block diagram of a power supply device according to an embodiment.

FIG. 5 is a first block diagram of a power supply device according to a first embodiment.

FIG. 6 is a block diagram of a first power conversion circuit according to the first embodiment.

FIG. 7 is a block diagram of a second power conversion circuit according to the first embodiment.

FIG. 8 is a block diagram of a second power conversion circuit according to the first embodiment, wherein the second power conversion circuit is a single input multiple output (SIMO).

FIG. 9 is a second block diagram of the power supply device according to a second embodiment.

FIG. 10 is a block diagram of a second power conversion circuit according to the second embodiment.

FIG. 11 is a block diagram of a second power conversion circuit according to the second embodiment, wherein the second power conversion circuit is a SIMO.

The sizes, shapes, and dimensions of components depicted in the drawings may differ from the actual figures. Furthermore, even if identical components are depicted with different sizes, shapes, and dimensions across the drawings, this is merely an example within the drawings, and identical components may have the same sizes, shapes, and dimensions across the drawings.

### MODE FOR INVENTION

Hereinafter, embodiments disclosed in this specification will be described in detail with reference to the accompanying drawings. Regardless of the drawing numbers, identical or similar components will be assigned the same reference numerals, and redundant descriptions thereof will be omitted. The suffixes “module” and “part” used in the following description for components are assigned or used interchangeably for ease of writing the specification, and do not inherently have distinct meanings or roles. Furthermore, the accompanying drawings are intended to facilitate understanding of the embodiments disclosed in this specification, and the technical concepts disclosed in this specification are not limited by the accompanying drawings. Also, when an element such as a layer, region, or substrate is referred to as existing ‘on’ another component, this comprises that it may be present directly on the other element, or that other intermediate elements may exist therebetween.

Hereinafter, VDR1 may be used interchangeably as a first voltage, a first driving voltage, and a first display driving voltage, VDR2 may be used interchangeably as a second voltage, a second driving voltage, and a second display driving voltage, and VDR3 may be used interchangeably as a third voltage, a third driving voltage, and a third display driving voltage.

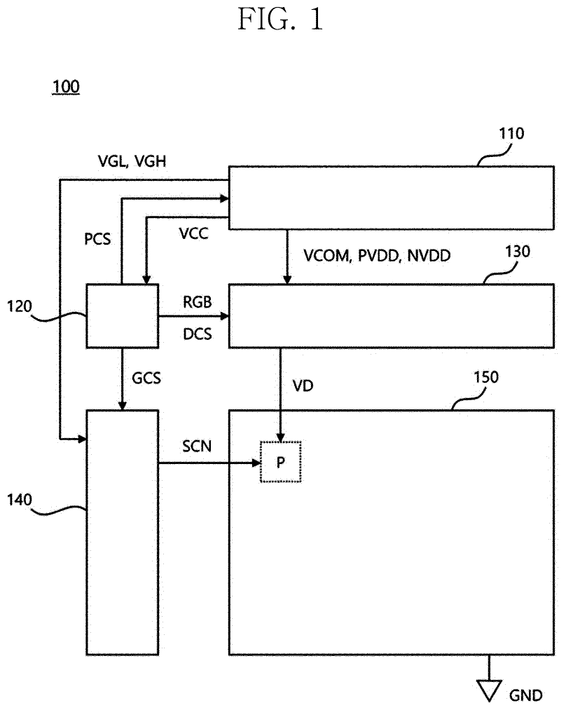

FIG. 1 is a block diagram of a display device according to an embodiment.

Referring to FIG. 1, the display device 100 may comprise display driving devices 110, 120, 130, and 140. For example, the display driving devices 110, 120, 130, and 140 may comprise a power supply device 110, a data processing device 120, a data driving device 130, a gate driving device 140, and a display panel 150.

The data processing device 120 may process image data RGB received from an external device to be suitable for the characteristics of the display panel 150 and transmit the processed image data RGB to the data driving device 130. The data processing device 120 may transmit a data control signal DCS to control and set the data driving device 130 to the data driving device 130.

The data processing device 120 may transmit a gate control signal GCS to control the scan timing of the display panel 150 to the gate driving device 140. The data processing device 120 may transmit a power control signal PCS to control the power supply device 110 to the power supply device 110.

The image data RGB, the data control signal DCS, the gate control signal GCS, and the power control signal PCS may be transmitted in frame units. For example, when the frame rate is 120 Hz, these signals may be transmitted once every 1/120 second, and when the frame rate is 240 Hz, these signals may be transmitted once every 1/240 second.

The data processing unit 120 may control the timing of the data driving device 130, the gate driving device 140, and the power supply device 110. In this respect, the data processing unit 120 is also referred to as a timing controller.

The data driving device 130 may convert the grayscale value of each pixel P included in the image data RGB into a data voltage VD and supply it to each pixel P of the display panel 150.

The data driving device 130 may transmit the data voltage VD to the display panel 150 in line units. For example, the data driving device 130 may select one of a plurality of lines formed on the display panel 150 and simultaneously transmit data voltages VD for pixels disposed on the selected line. The selection of the line may be determined by a scan signal SCN transmitted by the gate driving device 140.

A driving transistor for driving the pixel P may be disposed on each pixel P. The data driving device 130 may supply the data voltage VD to the source terminal of the driving transistor. In this respect, the data driving device 130 is also referred to as a source driver.

The gate driving device 140 may generate a scan signal SCN for selecting one line when the data voltage VD is supplied to the display panel 150. The scan signal SCN may be supplied to the gate terminal of the driving transistor disposed on each pixel P. In this respect, the gate driving device 140 is also referred to as a gate driver.

The power supply device 110 may supply display driving voltages VCC, VCOM, PVDD, NVDD, VGL, and VGH to the data processing unit 120, the data driving device 130, the gate driving device 140, and the display panel 150.

The driving voltages VCC, VCOM, PVDD, NVDD, VGL, and VGH may have different characteristics—e.g., voltage level, variability, dynamics, etc.—depending on the application. For example, the VCC driving voltage supplied to the data processing unit 120 may have low voltage level and low variability. The VCOM driving voltage and the NVDD driving voltage supplied to the data driving device 130 may be voltages having a negative polarity lower than the ground voltage GND of the display panel 150. The VGH driving voltage supplied to the gate driving device 140 may be a voltage with a positive polarity and may be a voltage with a high voltage level, and the VGL driving voltage may be a voltage with a negative polarity and may be a voltage having a high absolute voltage level.

The data processing unit 120 may perform operations on image data using the VCC driving voltage.

The data driving device 130 may generate a data voltage VD using the VCOM driving voltage, the PVDD driving voltage, and the NVDD driving voltage. The data driving device 130 may alternately supply the positive and negative data voltages VD to the pixel P. This driving method is also referred to as an inversion driving method. In the inversion driving method, the data driving device 130 may generate a positive data voltage using the VCOM driving voltage and the PVDD driving voltage. In the inversion driving method, the data driving device 130 may generate a negative data voltage using the VCOM driving voltage and the NVDD driving voltage.

The PVDD driving voltage may have a voltage level of approximately 5 V as a positive voltage, and the NVDD driving voltage may have a voltage level of approximately −5 V as a negative voltage, but is not limited thereto. The VCOM driving voltage may have a voltage level similar to the ground voltage GND of the display panel 150, or may be a negative voltage of approximately −0.7 V that is slightly lower than the ground voltage GND, but is not limited thereto.

The gate driving device 140 may supply the VGH driving voltage to a gate terminal of the driving transistor disposed in the pixel P to turn on the driving transistor. The gate driving device 140 may supply the VGL driving voltage to the gate terminal of the driving transistor disposed in the pixel P to turn off the driving transistor. The VGH driving voltage and the VGL driving voltage may have voltage levels with relatively high absolute values in order to reliably turn on or off the driving transistor. For example, the VGH driving voltage may have a voltage level of approximately 15 V, and the VGL driving voltage may have a voltage level of approximately −15 V, but is not limited thereto.

In this way, the display driving devices 110, 120, 130, and 140 may use driving voltages having various voltage levels. The power supply device 110 may comprise various types of power conversion circuits to generate these driving voltages. For example, the power supply device 110 may comprise a buck-type power conversion circuit to generate the VCC driving voltage. The buck-type power conversion circuit may be suitable for use when the output voltage is lower than the input voltage. The power supply device 110 may comprise a boost-type power conversion circuit to generate the PVDD driving voltage and the VGH driving voltage. The boost-type power conversion circuit may be suitable for use when the output voltage is higher than the input voltage. The power supply device 110 may comprise a buck-boost-type power conversion circuit to generate the VCOM driving voltage, the NVDD driving voltage, and the VGL driving voltage. The buck-boost-type power conversion circuit may be suitable for use when the output voltage has a negative polarity.

However, each type of power conversion circuit may exhibit low power conversion efficiency depending on the operating conditions. For example, a boost-type power conversion circuit may exhibit low power conversion efficiency when the duty cycle of the power switch is high. In a boost type, high duty cycles not only result in low power conversion efficiency but may also hinder normal operation. As another example, a buck-boost-type power conversion circuit may exhibit relatively lower power conversion efficiency when the duty cycle of the power switch is high. For example, in a buck-boost-type power conversion circuit, when the voltage levels of the input voltage and the output voltage differ significantly, the duty cycle may increase further. In this instance, the power conversion efficiency may be further reduced.

To increase the efficiency of such a power conversion circuit, the power supply device 110 according to the embodiment may supply a negative voltage generated in one power conversion circuit to the inductor of another power conversion circuit to improve the duty cycle of the other power conversion circuit. This can improve the overall power conversion efficiency of the power supply device.

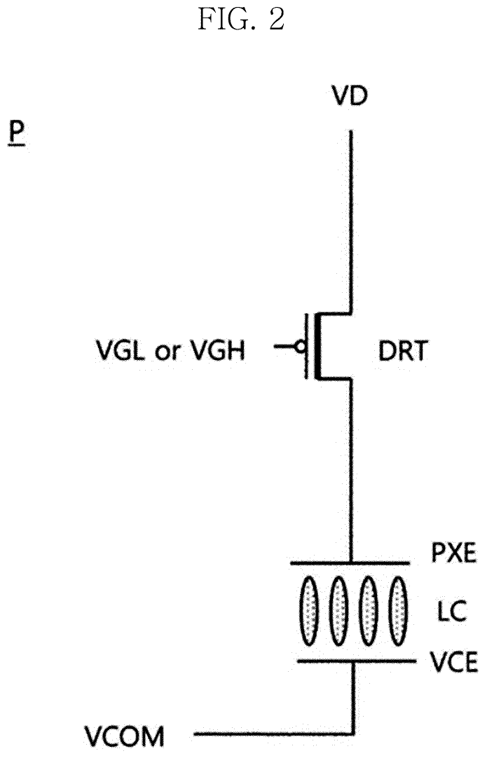

FIG. 2 illustrates pixels of a display panel according to an embodiment.

Referring to FIGS. 1 and 2, pixels P comprising liquid crystals (LCs) may be disposed on the display panel 150.

The alignment direction of the liquid crystals (LCs) may be determined by a voltage difference between the pixel electrode PXE and the common electrode VCE.

A common voltage VCOM may be supplied to the common electrode VCE. The common voltage VCOM is a voltage close to the ground voltage and may have a voltage level slightly lower than the ground voltage.

A data voltage VD may be supplied to the pixel electrode PXE. The data driving device 130 may control a voltage level of the data voltage VD while a voltage level of the common voltage VCOM is fixed to determine the alignment direction of the liquid crystal (LC), and may control the brightness of the pixel P according to the determined alignment direction of the liquid crystal (LC).

When the data voltage VD has a positive polarity, the liquid crystal (LC) may be aligned in a first direction-for example, upward direction. When the data voltage VD has a negative polarity, the liquid crystal (LC) may be aligned in a second direction-for example, downward direction. When the liquid crystal (LC) is aligned in only one direction, there is a problem that it cannot return to its original direction and leaves an afterimage on the display panel. To solve this problem, the liquid crystal (LC) may be aligned alternately in the first direction and the second direction.

To this end, the display driving devices 110, 120, 130, and 140 may generate a driving voltage having a negative polarity as well as a driving voltage having a positive polarity.

Meanwhile, a driving transistor DRT that controls the supply of a data voltage VD to the pixel electrode PXE may be disposed in the pixel P. The data driving device 130 may supply the data voltage VD to the pixel electrode PXE when the driving transistor DRT is turned on.

The driving transistor DRT may be turned on when a gate high voltage VGH is supplied to the gate terminal, and turned off when a gate low voltage VGL is supplied to the gate terminal. The gate high voltage VGH may be a voltage having a positive polarity, and the gate low voltage VGL may be a voltage having a negative polarity. Alternatively, depending on the type of driving transistor DRT, the gate high voltage VGH may have a negative polarity, and the gate low voltage VGL may have a positive polarity.

Accordingly, the gate driving device 140 may generate a gate driving voltage having a positive polarity and a gate driving voltage having a negative polarity.

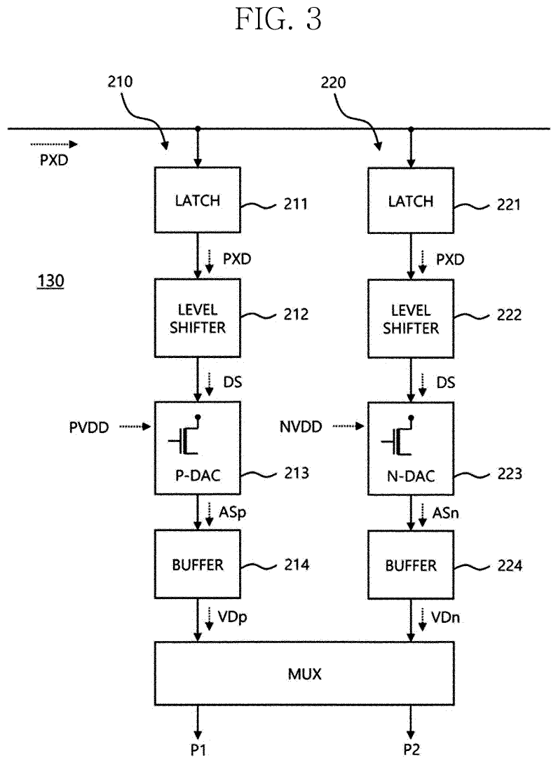

FIG. 3 is a block diagram of a data driving device according to an embodiment.

Referring to FIGS. 1 and 3, the data driving device 130 may comprise a first channel circuit 210 and a second channel circuit 220.

The first channel circuit 210 may convert pixel data PXD to generate a data voltage VDp having a positive polarity. The second channel circuit 220 may convert pixel data PXD to generate a data voltage VDn having a negative polarity. The data driving device 130 may alternately supply the data voltage VDp generated by the first channel circuit 210 and the data voltage VDn generated by the second channel circuit 220 to the first pixel P1 and the second pixel P2 of the display panel 150.

For example, the first channel circuit 210 may supply the data voltage VDp having a positive polarity to the first pixel P1 at a first time. The first channel circuit 210 may supply the data voltage VDp having a positive polarity to the second pixel P2 at a second time. The second channel circuit 220 may supply a data voltage VDn having a negative polarity to the second pixel P2 at a first time. The second channel circuit 220 may supply a data voltage VDn having a negative polarity to the first pixel Pl at a second time.

The first channel circuit 210 and the second channel circuit 220 may comprise latch circuits 211 and 221 and level shifters 212 and 222.

The latch circuits 211 and 221 may sequentially store pixel data PXD received through a data bus line.

The latch circuits 211 and 221 may each have two latches internally. The first latch may store pixel data to be output at the next horizontal time, and the second latch may store pixel data to be output at the current horizontal time. When the next horizontal time period arrives, the pixel data to be output in the next horizontal time period may be stored in the first latch, and the pixel data stored in the first latch may be moved to and stored in the second latch.

The output timing of the latch circuits 211 and 221 may be determined according to a latch output signal generated at each horizontal time period. The latch output signal may be synchronized with a horizontal synchronization signal. Alternatively, the latch output signal may be a signal with a different phase from the horizontal synchronization signal but the same period length.

The latch circuits 211 and 221 may transfer the pixel data PXD stored in the latch circuits 211 and 221 to the level shifters 212 and 222 according to the latch output signal.

Each of the level shifters 212 and 222 may convert the pixel data PXD into a digital signal DS. Each of the level shifters 212 and 222 may increase the signal level while converting pixel data PXD into a digital signal DS.

The pixel data PXD may be a signal with a low voltage or power level. Each of the level shifters 212 and 222 may convert the pixel data PXD into a digital signal DS with a high voltage or power level.

The first channel circuit 210 may comprise a P-DAC 213, and the second channel circuit 220 may comprise an N-DAC 223.

The P-DAC 213 may receive a positive PVDD driving voltage and convert the digital signal DS into a positive analog voltage ASp.

The N-DAC 223 may receive a negative NVDD driving voltage and convert the digital signal DS into a negative analog voltage ASn.

The buffer 214 included in the first channel circuit 210 may amplify the analog voltage ASp having a positive polarity to generate the data voltage VDp having a positive polarity. The buffer 224 included in the second channel circuit 220 may amplify the analog voltage ASn having a negative polarity to generate the data voltage VDn having a negative polarity.

The multiplexer MUX may supply an output of the first channel circuit 210 to the first pixel Pl at a first time and an output of the second channel circuit 220 to the second pixel P2 at a second time. The multiplexer MUX may supply an output of the first channel circuit 210 to the second pixel P2 at a second time and an output of the second channel circuit 220 to the first pixel P1.

As described above, the display device 100 requires the supply of driving voltages of various voltage levels. To supply driving voltages of various voltage levels, the power supply device 110 according to the embodiment may comprise a plurality of power conversion circuits.

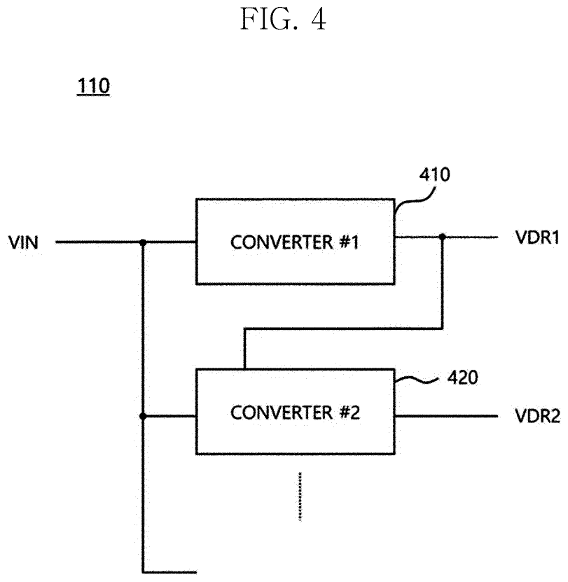

FIG. 4 is a block diagram of a power supply device according to an embodiment.

Referring to FIG. 4, the power supply device 110 may comprise a plurality of power conversion circuits 410 and 420.

Among the plurality of power conversion circuits 410 and 420, the first power conversion circuit 410 may receive an input voltage VIN and convert the input voltage VIN to generate a first voltage VDR1 having a negative polarity.

Among the plurality of power conversion circuits 410 and 420, the second power conversion circuit 420 may receive an input voltage VIN and a first voltage VDR1 and convert the input voltage VIN to generate a second voltage VDR2.

The second power conversion circuit 420 may comprise a plurality of power switches and inductors therein. The second power conversion circuit 420 may supply an input voltage VIN and a first voltage VDR1 to one side and the other side of the inductor, respectively, by controlling a first power switch. The second power conversion circuit 420 may output electric energy formed in the inductor as a second voltage VDR2 by controlling a second power switch.

The first voltage VDR1 may have a voltage level lower than the ground voltage of the load to which the second voltage VDR2 is supplied. When a voltage level of the ground voltage is 0 V, the first voltage VDR1 may be a voltage having a negative polarity. The second power conversion circuit 420 according to the embodiment may improve the duty cycle of the first power switch and enhance power conversion efficiency by additionally supplying a first voltage VDR1 lower than the ground voltage of the load to the inductor.

The first power conversion circuit 410 may operate, for example, in a buck-boost mode, and the second power conversion circuit 420 may operate in a buck-boost mode or a boost mode.

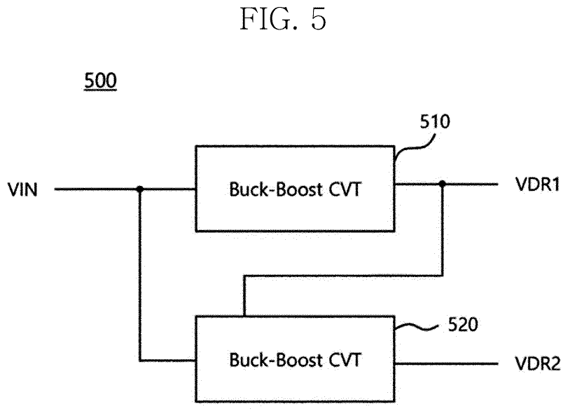

FIG. 5 is a first block diagram of a power supply device according to a first embodiment.

Referring to FIGS. 1 and 5, the power supply device 500 may comprise a first power conversion circuit 510, a second power conversion circuit 520, etc.

The first power conversion circuit 510 may generate a first driving voltage VDR1 having a negative polarity. The first driving voltage VDR1 may be supplied to the display driving device, i.e., the data driving device 130. For example, the first driving voltage VDR1 may be a VCOM driving voltage, an NVDD driving voltage, etc.

The first power conversion circuit 510 may receive a voltage of the system power as an input voltage VIN and may operate in a buck-boost mode while comprising a buck-boost type power stage. The voltage of the system power may have a voltage level of approximately 3.3 V, but is not limited thereto.

The second power conversion circuit 520 may receive the input voltage VIN and the first driving voltage VDR1, and may convert the input voltage VIN to generate a second driving voltage VDR2 having a negative polarity. The second driving voltage VDR2 may be supplied to the display driving device, i.e., the gate driving device 140. For example, the second driving voltage VDR2 may be a VGL driving voltage, etc.

An absolute value of a voltage level of the first driving voltage VDR1 may be lower than an absolute value of a voltage level of the second driving voltage VDR2. For example, the first driving voltage VDR1 may be −5 V, and the second driving voltage VDR2 may be −15 V, but is not limited thereto.

The first power conversion circuit 510 may supply the first driving voltage VDR1 to the N-DAC of a device that alternately supplies positive and negative voltages to a pixel P disposed on the display panel 150 using a P-DAC and an N-DAC.

The second power conversion circuit 520 is a device that drives a gate terminal of a driving transistor disposed on the pixel P, and may supply the second driving voltage VDR2 to the gate terminal of the driving transistor. The device may turn off the driving transistor using the second driving voltage VDR2.

Looking at the operating sequence, the second driving voltage VDR2 may be generated first, and the first driving voltage VDR1 may be generated next, but is not limited thereto.

Before the first driving voltage VDR1 is generated, the second power conversion circuit 520 may perform power conversion using a voltage having a higher voltage level than the first driving voltage VDR1—for example, a ground voltage—instead of the first driving voltage VDR1.

The first power conversion circuit 510 and the second power conversion circuit 520 may use a common input voltage VIN. The first power conversion circuit 510 may convert the input voltage VIN to generate the first driving voltage VDR1, and the second power conversion circuit 520 may convert the same input voltage VIN to generate the second driving voltage VDR2.

The first power conversion circuit 510 may comprise a buck-boost type power stage in which the input voltage VIN is transmitted to one side of an inductor and a ground voltage is supplied to the other side of the inductor.

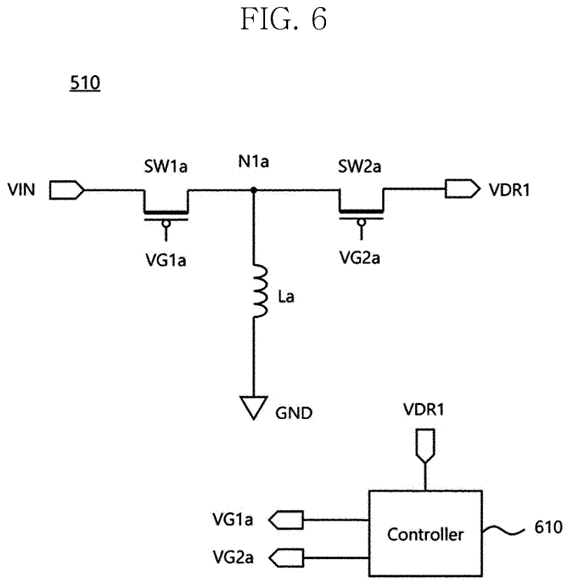

FIG. 6 is a block diagram of a first power conversion circuit according to the first embodiment.

Referring to FIG. 6, the first power conversion circuit 510 may comprise a first power switch SW1a that transmits the input voltage VIN to a first node N1a. During a time period in which the first power switch SW1a is turned on, an input voltage VIN may be transmitted to the first node N1a.

The first power conversion circuit 510 may comprise an inductor La, one end of which is electrically connected to the first node N1a and the other end of which is supplied with a ground voltage GND.

The first power conversion circuit 510 may comprise a second power switch SW2a that controls an electrical connection between the first node N1a and a load. During a time period in which the second power switch SW2a is turned on, a first driving voltage VDR1 may be transmitted to the first node N1a.

When the first power switch SW1a is turned on, the second power switch SW2a may be turned off, and when the first power switch SW1a is turned off, the second power switch SW2a may be turned on.

When the input voltage VIN is supplied to one side of the inductor La during a time period in which the first power switch SW1a is turned on, electrical energy may be stored in the inductor La. When the second power switch SW2a is turned on, the electrical energy stored in the inductor La may be output as the first driving voltage VDR1.

The first power conversion circuit 510 may comprise a controller 610. The controller 610 receives the first driving voltage VDRI as feedback, and generates a gate control signal VG1a for the first power switch SW1a and a gate control signal VG2a for the second power switch SW2a according to the first driving voltage VDR1, so that the first power conversion circuit 510 may be operated in a buck-boost mode.

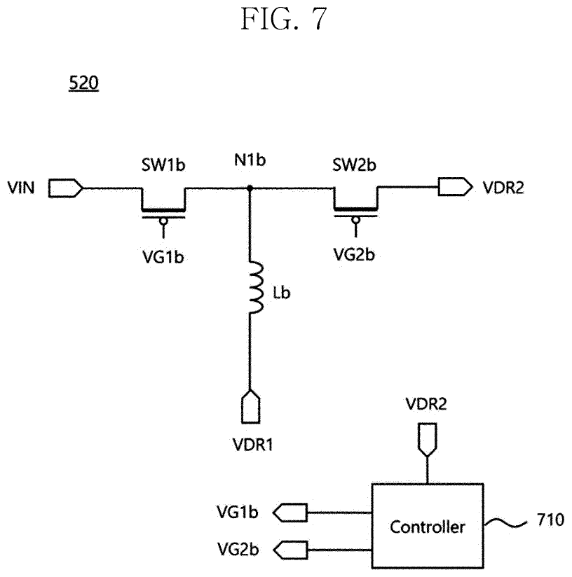

FIG. 7 is a block diagram of a second power conversion circuit according to the first embodiment.

Referring to FIG. 7, the second power conversion circuit 520 may comprise a first power switch SW1b that transmits an input voltage VIN to a first node N1b. The input voltage VIN may be transmitted to the first node N1b during a time period in which the first power switch SW1b is turned on.

The second power conversion circuit 520 may comprise an inductor Lb, one end of which is electrically connected to the first node N1b and the other end of which is supplied with a first driving voltage VDR1.

The second power conversion circuit 520 may comprise a second power switch SW2b that controls an electrical connection between the first node N1b and a load. The second driving voltage VDR2 may be transmitted to the first node N1b during a time period in which the second power switch SW2b is turned on.

When the first power switch SW1b is turned on, the second power switch SW2b may be turned off, and when the first power switch SW1b is turned off, the second power switch SW2b may be turned on.

During the time period in which the first power switch SW1b is turned on, a voltage (VIN-VDR1), which is the difference between the input voltage VIN and the first driving voltage VDR1, is supplied to both terminals of the inductor Lb, so that electrical energy may be stored in the inductor Lb. During the time period in which the second power switch SW2b is turned on, the electrical energy stored in the inductor Lb, i.e., the voltage (VIN-VDR1), may be output as the second driving voltage VDR2.

The second power conversion circuit 520 may comprise a controller 710. The controller 710 receives the second driving voltage VDR2 as feedback, and generates a gate control signal VG1b for the first power switch SW1b and a gate control signal VG2b for the second power switch SW2b according to the second driving voltage VDR2, so that the second power conversion circuit 520 may be operated in a buck-boost mode.

Meanwhile, the duty D1 for the first power switch SW1a may be calculated as VDR2/(VDR2−VIN) when the ground voltage is supplied to the other side of the inductor Lb. For example, when the second driving voltage VDR2 is −15 V and the input voltage is 3.3 V, the duty D1 may be calculated as −15/( −15-3.3) =82%. When the duty D1 is high, the power conversion efficiency may be low.

In contrast, when the first driving voltage VDR1 having a negative polarity is supplied to the other side of the inductor Lb as illustrated in FIG. 7, the duty D1 may be calculated as (VDR2−VDR1)/(VDR2−VIN). For example, when the second driving voltage VDR2 is −15 V, the input voltage is 3.3 V, and the first driving voltage VDR1 is −5 V, the duty D1 may be calculated as (−15+5)/(−15−3.3)=54.6%. When the duty D1 is lowered in this way, the power conversion efficiency can be increased.

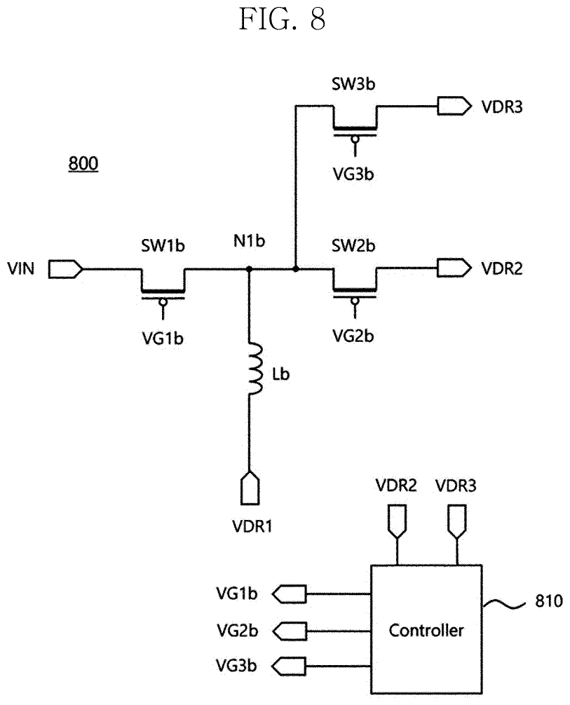

FIG. 8 is a block diagram of a second power conversion circuit according to the first embodiment, wherein the second power conversion circuit is a SIMO.

Referring to FIG. 8, the second power conversion circuit 800 may further generate a third driving voltage VDR3 having a negative polarity, compared to the second power conversion circuit 520 described with reference to FIG. 7.

The second power conversion circuit 800 may further comprise a third power switch SW3b that controls the electrical connection between the first node Nlb and the load. The second power conversion circuit 800 may generate a third driving voltage VDR3 having a negative polarity by controlling the third power switch SW3b.

The controller 810 may receive the second driving voltage VDR2 and the third driving voltage VDR3 as feedback, and generate gate control signals VG1b, VG2b, and VG3b for the first power switch SW1b, the second power switch SW2b, and the third power switch SW3b according to the second driving voltage VDR2 and the third driving voltage VDR3.

Meanwhile, the second driving voltage VDR2 may be supplied to a first load, and the third driving voltage VDR3 may be supplied to a second load. The first driving voltage VDR1 may have a voltage level lower than the ground voltage of the first and second loads.

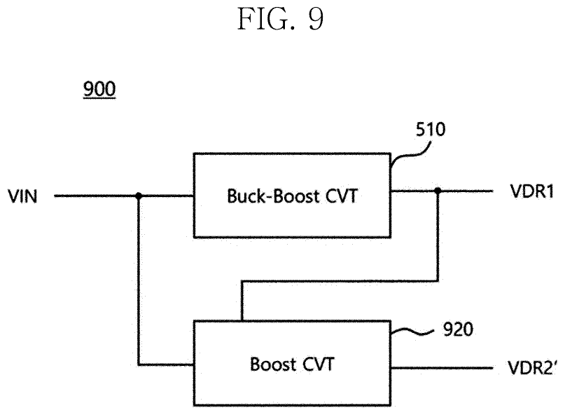

FIG. 9 is a second block diagram of the power supply device according to a second embodiment.

Referring to FIGS. 1 and 9, the power supply device 900 may comprise a first power conversion circuit 510, a second power conversion circuit 920, etc.

The first power conversion circuit 510 may generate a first driving voltage VDR1 having a negative polarity. The first driving voltage VDR1 may be supplied to a display driving device, i.e., a data driving device 130. For example, the first driving voltage VDR1 may be a VCOM driving voltage, an NVDD driving voltage, etc.

The first power conversion circuit 510 may receive a voltage of the system power as an input voltage VIN, and may operate in a buck-boost mode while comprising a buck-boost type power stage. The voltage of the system power may have a voltage level of approximately 3.3 V.

The second power conversion circuit 920 may receive the input voltage VIN and the first driving voltage VDR1, and convert the input voltage VIN to generate a second driving voltage VDR2′ having a positive polarity. The second driving voltage VDR2′ may be supplied to the display driving device, i.e., the gate driving device 140. For example, the second driving voltage VDR2′ may be a VGH driving voltage, etc.

An absolute value of a voltage level of the first driving voltage VDR1 may be lower than an absolute value of a voltage level of the second driving voltage VDR2. For example, the first driving voltage VDR1 may be −5 V, and the second driving voltage VDR2′ may be 15 V.

The first power conversion circuit 510 may supply the first driving voltage VDR1 to the N-DAC of a device that alternately supplies positive and negative voltages to a pixel P disposed on the display panel 150 using the P-DAC and the N-DAC.

The second power conversion circuit 920 is a device that drives a gate terminal of a driving transistor disposed in a pixel P, and may supply a second driving voltage VDR2′ to the gate terminal of the driving transistor. The device may turn on the driving transistor using the second driving voltage VDR2′.

Looking at the operating sequence, the second driving voltage VDR2′ may be generated first, and the first driving voltage VDR1 may be generated next.

Before the first driving voltage VDR1 is generated, the second power conversion circuit 920 may perform power conversion using a voltage having a higher voltage level than the first driving voltage VDR1—for example, a ground voltage—instead of the first driving voltage VDR1.

The first power conversion circuit 510 and the second power conversion circuit 920 may use a common input voltage VIN. The first power conversion circuit 510 may convert an input voltage VIN to generate a first driving voltage VDR1, and the second power conversion circuit 920 may convert the same input voltage VIN to generate a second driving voltage VDR2′.

The first power conversion circuit 510 may comprise a buck-boost type power stage in which the input voltage VIN is transmitted to one side of the inductor and a ground voltage is supplied to the other side.

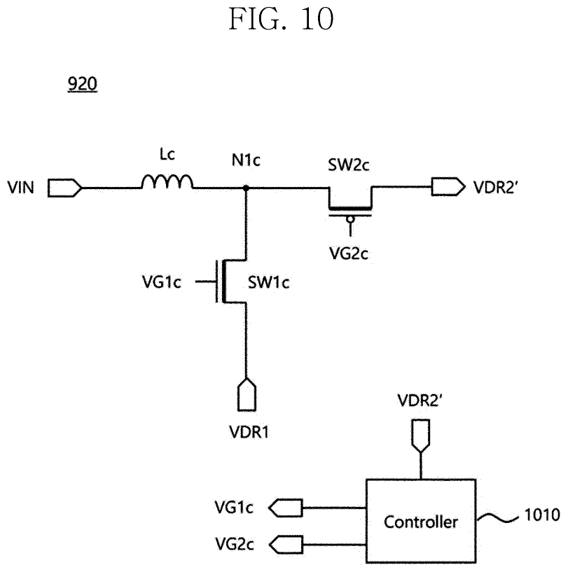

FIG. 10 is a block diagram of a second power conversion circuit according to the second embodiment.

Referring to FIG. 10, the second power conversion circuit 920 may comprise an inductor Lc, one side of which is electrically connected to a first node Nlc and the other side of which is supplied with the input voltage VIN.

The second power conversion circuit 920 may comprise a first power switch SW1c that transmits a first driving voltage VDR1 to a first node NIc during a time period in which the first power switch SW1c is turned on. The first driving voltage VDR1 may be transmitted to the first node Nlc during a time period in which the first power switch SW1c is turned on.

The second power conversion circuit 920 may comprise a second power switch SW2c that controls an electrical connection between the first node Nlc and a load. The second driving voltage VDR2′ may be transmitted to the first node NIc during a time period in which the second power switch SW2c is turned on.

When the first power switch SW1c is turned on, the second power switch SW2c may be turned off, and when the first power switch SW1c is turned off, the second power switch SW2c may be turned on.

During a time period when the first power switch SW1c is turned on, a voltage (VIN-VDR1) obtained by subtracting the first driving voltage VDR1 from the input voltage VIN is supplied to both terminals of the inductor Lc, and electrical energy may be stored in the inductor Lc. During a time period when the second power switch SW2c is turned on, the electrical energy stored in the inductor Lc, i.e., the voltage (VIN-VDR1), may be output as the second driving voltage VDR2′.

The second power conversion circuit 920 may comprise a controller 1010. The controller 1010 receives the second driving voltage VDR2′ as feedback, and generates a gate control signal VGlc for the first power switch SWIc and a gate control signal VG2c for the second power switch SW2c according to the second driving voltage VDR2′, so that the second power conversion circuit 920 may be operated in a boost mode.

Meanwhile, the duty D1 for the first power switch SW1c may be calculated as 1−VIN/VDR2′ when the ground voltage is supplied to one side of the inductor Lc. For example, when the second driving voltage VDR2′ is 15 V and the input voltage is 3.3 V, the duty D1 may be calculated as 1−3.3/15 =78%. When the duty D1 is high like this, the power conversion efficiency may be low.

In contrast, when the first driving voltage VDR1 having a negative polarity is supplied to one side of the inductor Lc as illustrated in FIG. 10, the duty D1 may be calculated as 1−(VIN−VDR1)/(VDR2′−VDR1). For example, when the second driving voltage VDR2′ is 15 V, the input voltage is 3.3 V, and the first driving voltage VDR1 is-5 V, the duty D1 may be calculated as 1-(3.3 +5) / (15 +5) =58.5%. When the duty D1 is lowered in this way, the power conversion efficiency can be increased.

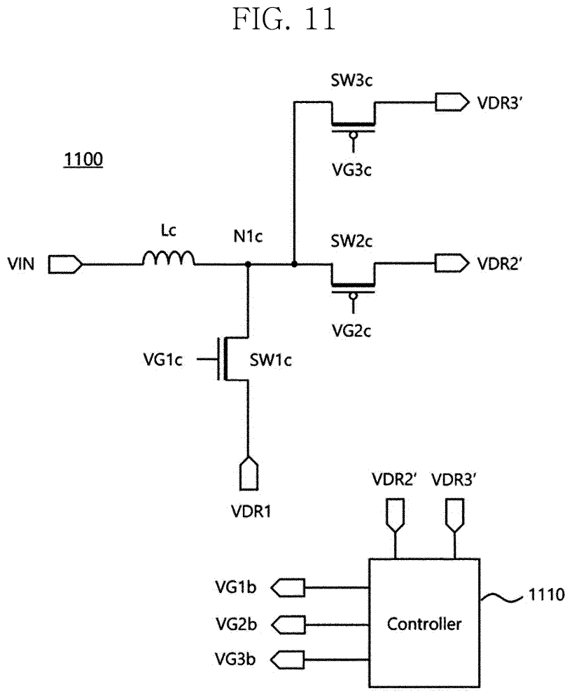

FIG. 11 is a block diagram of a second power conversion circuit according to the second embodiment, wherein the second power conversion circuit is a SIMO.

Referring to FIG. 11, the second power conversion circuit 1100 may further generate a third driving voltage VDR3′ having a negative polarity, compared to the second power conversion circuit 920 described with reference to FIG. 10.

The second power conversion circuit 1100 may further comprise a third power switch SW3c that controls the electrical connection between the first node Nlc and the load. The second power conversion circuit 1100 may generate a third driving voltage VDR3′ having a negative polarity by controlling the third power switch SW3c.

The controller 1110 receives the second driving voltage VDR2′ and the third driving voltage VDR3 as feedback, and may generate gate control signals VG1c, VG2c, and VG3c for the first power switch SW1c, the second power switch SW2c, and the third power switch SW3c according to the second driving voltage VDR2′ and the third driving voltage VDR3′.

Meanwhile, the second driving voltage VDR2′ may be supplied to a first load, and the third driving voltage VDR3′ may be supplied to a second load. The first driving voltage VDR1 may have a voltage level lower than the ground voltage of the first and second loads.

As described above, according to the embodiment, the efficiency of the power supply device can be increased. According to the embodiment, in a power supply device that supplies a voltage having a negative polarity, the efficiency of the power supply device can be further increased by utilizing the voltage having a negative polarity. According to an embodiment, the duty cycle of a power conversion circuit used in a power supply device may be improved, thereby increasing overall efficiency. According to an embodiment, the efficiency of a buck-boost-type power conversion circuit and a boost-type power conversion circuit can be increased.

The above detailed description should not be construed as limiting in any respect and should be considered illustrative. The scope of the embodiments should be determined by a reasonable interpretation of the appended claims, and all modifications within the equivalent scope of the embodiments are included within the scope of the embodiments.

1. A display power supply device, comprising:
a first power conversion circuit configured to generate a first display driving voltage having a negative polarity;
a second power conversion circuit comprising:
a first power switch configured to transmit an input voltage to a first node,
an inductor having one end electrically connected to the first node and the other end to which the first display driving voltage is supplied, and
a second power switch configured to control an electrical connection between the first node and a first load,
wherein the second power conversion circuit is configured to generate a second display driving voltage having a negative polarity by controlling the first and second power switches in a buck-boost mode.

2. The display power supply device of claim 1, wherein an absolute value of a voltage level of the first display driving voltage is lower than an absolute value of a voltage level of the second display driving voltage.

3. The display power supply device of claim 2, wherein the first power conversion circuit is configured to supply the first display driving voltage to an N-DAC of a device that alternately supplies positive and negative voltages to a pixel disposed on a display panel using a P-DAC and the N-DAC.

4. The display power supply device of claim 3, wherein the second power conversion circuit is a device that drives a gate terminal of a driving transistor disposed in the pixel, and is configured to supply the second display driving voltage

5. The display power supply device of claim 1, wherein the second display driving voltage is configurated to be generated before the first display driving voltage.

6. The display power supply device of claim 1, wherein the first power conversion circuit is configurated to convert the input voltage to generate the first display driving voltage.

7. The display power supply device of claim 6, wherein the first power conversion circuit comprises a buck-boost type power stage in which the input voltage is transferred to one side of the inductor and a ground voltage is supplied to the other side thereof.

8. The display power supply device of claim 1, wherein the first display driving voltage has a voltage level lower than ground voltages of the first load and a second load.

9. The display power supply device of claim 1, wherein a duty of the second power switch is determined by dividing a value obtained by subtracting the first display driving voltage from the second display driving voltage by a value obtained by subtracting the input voltage from the second display driving voltage.

10. The display power supply device of claim 1, wherein the second power conversion circuit further comprises a third power switch configured to control an electrical connection between the first node and a second load, and is configured to control the first and third power switches to further generate a third display driving voltage having a negative polarity.

11. A display power supply device, comprising:
a first power conversion circuit configured to generate a first display driving voltage having a negative polarity; and
a second power conversion circuit comprising:
an inductor having one end electrically connected to a first node and the other end to which an input voltage is supplied,
a first power switch configured to transmit a first display driving voltage to the first node, and
a second power switch configured to control an electrical connection between the first node and a first load,
wherein the second power conversion circuit is configured to generate a second display driving voltage by controlling the first and second power switches in a boost mode.

12. The display power supply device of claim 11, wherein the input voltage and the second display driving voltage have positive polarities, and a voltage level of the input voltage is lower than a voltage level of the second display driving voltage.

13. The display power supply device of claim 11, wherein the first power conversion circuit is configured to supply the first display driving voltage to an N-DAC of a device that alternately supplies positive and negative voltages to a pixel disposed on a display panel using a P-DAC and the N-DAC.

14. The display power supply device of claim 13, wherein a driving transistor disposed in the pixel is turned on by the second display driving voltage.

15. The display power supply device of claim 11, wherein the first display driving voltage has a voltage level lower than a ground voltage of the first load.

16. The display power supply device of claim 11, wherein a duty of the second power switch is determined by dividing a value obtained by subtracting the first display driving voltage from the input voltage by a value obtained by subtracting the first display driving voltage from the second display driving voltage.

17. The display power supply device of claim 11, wherein the second power conversion circuit further comprises a third power switch configured to control an electrical connection between the first node and a second load, and is configured to control the first and third power switches to further generate a third display driving voltage.

18. A power supply device, comprising:
a first power conversion circuit configured to generate a first voltage having a negative polarity; and
a second power conversion circuit configured to supply an input voltage and the first voltage to one end and the other end of an inductor, respectively, by controlling a first power switch, and to output electric energy generated in the inductor as a second voltage by controlling a second power switch.

19. The power supply device of claim 18, wherein the first voltage has a voltage level lower than a ground voltage of a load to which the second voltage is supplied.

20. The power supply device of claim 18, wherein the first power conversion circuit is configured to operate in a buck-boost mode, and the second power conversion circuit is configured to operate in a buck-boost mode or a boost mode.
